(19) United States
(12) Patent Application Publication
(10) Pub. No.: US 2006/0107835 A1
(43) Pub. Date: May 25, 2006

(54) Air conducting channel

(75) Inventors: Tanja Heilmann, Haan (DE); Frank Pfeiffer, Moensheim (DE); Alrun Spennemann, Stuttgart (DE); Andreas Franz, Ludwigsburg (DE)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 11/280,308

(22) Filed: Nov. 17, 2005

(30) Foreign Application Priority Data
Nov. 17, 2004 (DE) 10 2004 000 046.8

(51) Int. Cl. B01D 53/02

(52) U.S. Cl. 96/108

(57) ABSTRACT

A channel for conducting a gaseous medium, particularly an air conducting channel for an internal combustion engine, having at least one channel section that is produced in an extrusion blow molding process. The blow-molded channel section has adsorption particles on its inside walls, which are attached in an interlocked manner to the inside wall of the channel section in the blow molding process.

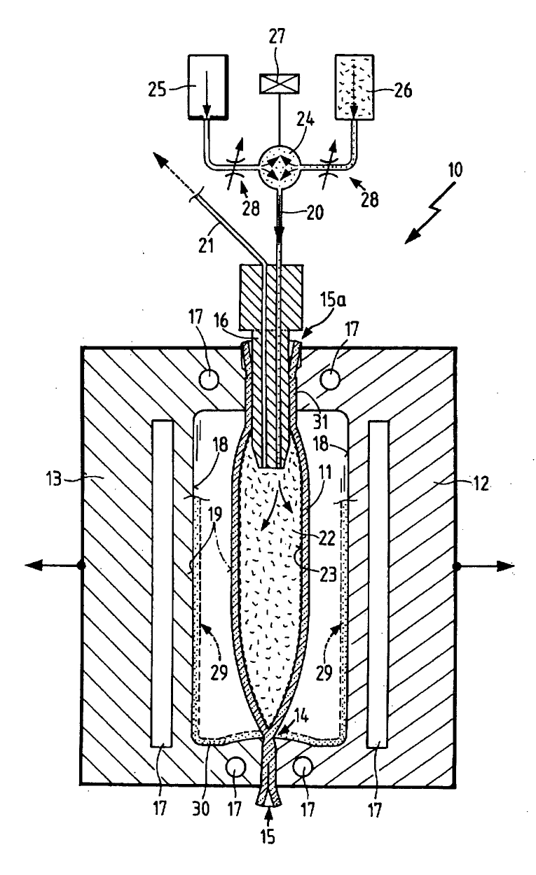

### BACKGROUND OF THE INVENTION

The invention relates to an air conducting channel in accordance with the species of claim 1. The invention further relates and to a process for manufacturing an air conducting channel of this type.

An essential goal in the design of modern internal combustion engines is to reduce emission of harmful substances. Until now, the development activities have focused primarily on optimizing the exhaust emission control system. Modern exhaust emission control systems meanwhile achieve conversion rates for harmful substances greater than 97%.

Increasing air pollution has led most countries to limit emissions and to continue to tighten these limits. To assure reproducibility and comparability, various test methods, ratings and limits have been developed. In the United States, for example, the limits include the categories ULEV (Ultra Low Emission Vehicle), SULEV (Super Ultra Low Emission Vehicle) and the currently strictest category, PZEV (Partial Zero Emission Vehicle).

In connection with the above-described SULEV/ULEV problem, the disadvantage, however, is that hydrocarbons present in the intake manifold of an internal combustion engine, for example, may escape into the environment when the engine is stopped. It may be necessary to minimize the occurrence of hydrocarbon emissions in order to comply with the limits specified by law. It is also desirable to remove unburned hydrocarbons from the air conducted into the passenger compartment of automotive vehicles.

To solve this problem, components with adsorbent-containing filter elements are used in air circuits. Typically, the air conducting channels are made of synthetic resin material (i.e., plastic). The filter elements used are intended to reduce hydrocarbon emissions and/or prevent the discharge of hydrocarbon emissions that do occur. The filter elements are usually designed as pleated filters, ceramic-based solid structures, adsorbent-containing pressed materials or adsorbent beds. As a result, they require a special housing adapted to a given filter type and must be connected to the air circuits in an additional production or packaging step. The conventional filter elements, such as zigzag-shaped pleated filters are usually constructed as replaceable cartridge filters.

Published U.S. patent application no. US 2003/082824 A1 discloses an air conducting channel with an integrated hydrocarbon sensor and collector. This hydrocarbon sensor and collector is disk shaped and is positioned inline in the airflow flowing through the air conducting channel. The adsorbent element has a honeycomb structure and is preferably made from activated carbon or activated carbon and a binder.

German patent no. DE 44 27 793 C2 discloses an air conducting housing having two reactors for adsorbing noxious and aromatic substances. These reactors separate a main air chamber from two side air chambers, such that, in operation, one reactor functions as an adsorbent while the other reactor undergoes desorption. The reactors are configured as heat exchangers, synthetic foam or grids having a coating of an adsorbent material, such as activated carbon, zeolite or the like.

Drawbacks in all of these solutions include the high complexity involved in their production, the considerable pressure loss which may occur across the adsorbent filter, and the need for special adaptation of the housing and air conducting channels to the adsorbent elements.

### SUMMARY OF THE INVENTION

Accordingly, it is an object of the present invention to provide an improved air conducting channel.

Another object of the invention is to provide an air conducting channel which avoids the aforementioned drawbacks.

A further object of the invention is to provide an air conducting channel with adsorbent particles on its inside wall which can be manufactured in a simple and cost-effective manner.

It is also an object of the invention to provide a new method for producing an air conducting channel with adsorbent particles on its inside wall, as well as a method of separating hydrocarbons from an air stream.

These and other objects are achieved in accordance with the present invention by providing a channel for conducting a gaseous medium comprising at least one channel section produced in an extrusion blow molding process, in which the blow-molded channel section has adsorbent particles along its inside wall, which are attached to the inside wall of the channel in an interlocked manner.

In accordance with a further aspect of the invention, the objects are achieved by providing a method of producing a gas conducting channel section having adsorbent particles along its inside wall, which are attached to the inside wall of the channel in an interlocked manner, comprising extruding a tubular preform; introducing the extruded preform while its walls are still soft into a blow mold having inside walls in the shape of the channel section; sealing the ends of the preform in the blow mold; and injecting a gas under pressure into the preform to inflate the preform and press the preform against the inside walls of the blow mold, and allowing the preform to solidify against the walls of the blow mold; in which adsorbent particles are introduced into the preform with the injected gas such that the particles are embedded in an interlocked manner in the inside wall of the blow molded preform.

The channel for conducting a gaseous medium according to the invention, particularly an air conducting channel in the area of an internal combustion engine, comprises at least one channel section that is produced in an extrusion blow molding process. The channel section may have a round, oval, angular or other cross sectional shape and may either fully consist of the channel section produced in the extrusion blow molding process or be a combination of channel sections in the form of two shells and an additional channel section produced in an extrusion blow molding process. The extrusion blow molding process has the advantage that the cross sectional geometry and the axial course of the channel section can be relatively freely configured.

According to the invention, adsorbent particles are disposed on the inside wall of the blow-molded channel section and are attached to the inside wall of the channel section in a form-fitting or interlocked manner. For example, the channel section may be coated with an adhesive along its inside wall and the adsorbent particles may be bonded to the inside wall. Preferably, however, the adsorbent particles are injected directly into the interior of the still hot preform in the production process, i.e., in the extrusion blow molding process, using a compressed gas, e.g., the compressed air for inflating the preform. The adsorbent particles become attached to the inside wall of the preform, which is still almost in a molten state, in that the adsorbent particles are partly taken up and held by the melt along the inner surface of the inside wall and thereby become partially embedded in the inside wall, without, however, being able to pass through the wall to the outside.

It is particularly advantageous that an adsorbent-containing channel section can be produced in a single process step without any need for additional adsorbent-containing filters or adsorbent-containing components to adsorb undesirable gas components. Because of the particularly high flexibility in the forming process, blow molding easily makes it possible to produce complex shapes cost-effectively and to implement an additional function, i.e., adsorbability.

In accordance with one advantageous embodiment of the invention, the partial blow-molded channel shell is made of a simple thermoplastic material. Conventional channel sections in intake lines of internal combustion engines are made of a polyamide. This polyamide has a low gas permeation rate and is correspondingly costly to purchase. For example, to prevent unburned hydrocarbons, which can migrate from the cylinder space back into the intake line when the engine is stopped, from escaping into the environment, the standard synthetic resin material selected for the channel sections must be very dense. On the other hand, if adsorbents are embedded in the channel sections as proposed in the present invention, it is possible to use less expensive synthetic resin materials with a higher gas permeation rate, such as polypropylene, because the hydrocarbons are adsorbed from the gas space by the adsorbent particles. Because the adsorbent particles are positioned directly in the air conducting channels, the air flowing through the channels automatically regenerates the adsorbent particles during normal operation of the internal combustion engine.

In another advantageous embodiment of the invention, only a defined axial portion of the inside wall of the blow-molded channel section is doped with adsorbent particles. Thus, it is possible to provide only a specific region of the line channels or, e.g. in curved channel sections, only a curved area with adsorbent particles. The sites where a high concentration of hydrocarbons is present when the internal combustion engine is stopped can be determined experimentally, so that those sites, in particular, can be provided with adsorbent particles.

It is advantageous to use adsorbent particles in the form of activated carbon. To this end, the activated carbon particles must be flowable in order to be able to be linked to the inside wall of the channel section in the extrusion blow molding process. It is possible to use granulated activated carbon, activated carbon chips or spherical activated carbon. It is also feasible to use zeolites or silica gel.

The process according to the invention for producing a channel section in accordance with one of the preceding embodiments may be described as follows: For extrusion blow molding, the synthetic resin material used for the channel section is melted in the extruder and a tubular preform is produced. This preform is introduced into a blow mold, which on the one hand is the negative of the outer contour of the finished component and on the other hand seals the ends of the tube by crimping the lower end and inserting a connection piece into the upper opening to seal this opening and at the same time insert an injector nipple. Air or another inflation gas is usually injected through the injector nipple at a pressure of several bar, such that the preform is inflated until it contacts the wall of the mold, is shaped according to the contour of the mold and solidifies along this wall, which is cold (relative to the melt).

According to the invention, the injector nipple has not only an air supply duct, in which the air may also be preheated, but also an adsorbent feed line and a mixing head, so that, as the preform is shaped, the adsorbent particles, which are in flowable form (e.g., activated carbon powder or granules) are simultaneously injected and penetrate the inner layer of the tube close to the surface. The adsorbent particles thus become permanently attached to the inside wall of the channel section and form an adsorbent surface layer for hydrocarbons, for example.

The temperature in the blow mold must be controlled in such a way that the melt viscosity is high enough to receive the adsorbent particles along the inner surface but the adsorbent particles are prevented from passing through the wall of the channel section to the outside. On the other hand, the melt must be liquid enough to enable an intimate union between the synthetic resin material and the adsorbent particles.

As a result of the invention, a dual function is imparted to the air conducting sections in a single production step, i.e., air conducting on the one hand and reduction of unburned hydrocarbons on the other. This has the advantage of reducing other interfaces in the system because there is no need to install additional filter elements, which in turn means that no additional components need to be used and the filter function can be integrated into existing components. This saves space and simplifies both the assembly of the systems and any subsequent adaptation of existing systems.

Furthermore, the pressure loss in the system according to the invention is lower than in a system with an added filter element. The hydrocarbon reduction can thus also be used locally and flexibly, e.g., near the source or at sites that are difficult to access for filter elements, e.g., in pipe curvatures. The coating with adsorbent particles also prevents hydrocarbons from permeating through the synthetic resin material component, so that less costly synthetic resin materials may be used.

In accordance with yet another advantageous embodiment of the invention, the metering or addition of the adsorbent particles is controlled by the mixing head. This makes it possible to control the introduction of the adsorbent particles in accordance with appropriate specifications. This has the advantage that the amount of the adsorbent particles being injected can be controlled and adapted to the installation situation and the level of hydrocarbon emissions which are expected to be encountered.

As an alternative, the adsorbent particles may be added at predefined time intervals, which in combination with corresponding temperature control in the mold and the preform can lead to a partial doping of the channel section with adsorbent particles.

The channel section according to the invention may be used to adsorb unburned hydrocarbons, e.g., in an air conducting channel for the intake air of an internal combustion engine, or in an air conducting channel used to supply air to the interior of an automotive vehicle. If it is used in the air conducting channel for the intake air, the channel section according to the invention serves to reduce hydrocarbon emissions when the engine is stopped in order to meet the applicable limits and requirements imposed on the automobile manufacturer. If it is used as an air conducting channel to supply air to the interior of an automotive vehicle, the channel section serves rather to reduce noxious gases and odors before they can reach the interior of the vehicle and the passengers.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWING

The invention will be described in further detail hereinafter with reference to an illustrative preferred embodiment shown in the accompanying drawing FIGURE which is a schematic view of an extrusion blow molding apparatus for producing an air conducting channel according to the invention.

### DETAILED DESCRIPTION OF PREFERRED EMBODIMENTS

The single FIGURE shows a blow molding unit 10 with a preform 11 in the form of a tube which was introduced directly into the blow molding unit 10 of an extrusion machine (not shown). As a result, the preform 11 still has a very high temperature and relatively low viscosity, that is to say, the walls are still soft and deformable. The preform is clamped between two mold sections 12 and 13, such that in the lower region where the mold sections 12, 13 meet, a crimped area 14 results, where the tubular synthetic resin material material of the preform 11 is joined again, and such that the excess thereof, the so-called parison waste 15, is pinched off the preform 11. In the upper region of the mold sections 12, 13, the preform 11 is pressed by the mold sections 12, 13 against an injector nipple 16 extended into the interior of the preform 11, such that excess parison waste 15a of the preform 11 is again pinched off.

Cooling channels 17 are disposed in the mold sections 12, 13 to cool the metal mold consisting of the two mold sections 12, 13. After completion of the inflation process, the inside walls 18 of the mold sections 12, 13 form the boundary for the outside walls 19 of the channel section 29 blow molded from the preform 11, which is partially illustrated in broken lines.

The preform is inflated via an air supply channel 20 in the injector nipple 16. After the inflation process is complete, the injected air is discharged again via an air discharge channel 21, which is likewise disposed in the injector nipple 16, since an elevated pressure of several bars is necessary for inflation. The adsorbent particles 22 are introduced into the preform 11 through the air supply channel 20 together with the injected pressurized air or other gas used for inflation, and the particles 22 become embedded in the still low-viscosity, soft inside wall 23 of the preform 11.

Because a viscosity gradient from the interior to the exterior is created in the wall of the preform 11, such that the outside wall 19 has a higher viscosity than the inside wall 23, the adsorbent particles 22 can fix themselves to the inside wall 23 but cannot pass through the outside wall 19. This viscosity gradient occurs because the cooled mold sections 12, 13 of the blow mold cool the outside wall 19 of the preform 11 much more rapidly than the inside wall 23 of the preform 11 due to their direct contact with the outside wall.

The air supply channel 20 communicates with a mixing chamber 24. The mixing chamber 24 in turn is connected to a compressed air supply 25, an adsorbent reservoir 26, and a control unit 27. The control unit 27 controls the mixing ratio of adsorbent particles supplied from the adsorbent reservoir 26 via injection nozzles 28 into the mixing chamber 24 together with the compressed air, which is supplied from the compressed air supply 25 through additional injection nozzles 28. Thus, the start and the intensity or amount of the adsorption particles supplied can be controlled by the control unit 27. The mixing chamber 24 is preferably constructed in such a way that its geometric configuration ensures that the compressed air is thoroughly mixed with the adsorbent particles 22, so that the injected compressed air/adsorbent particle mixture is well distributed in the preform 11 and uniformly dopes the inside wall 23 with adsorbent particles 22.

After the inflation process, when the blow molded preform 11 has been forced into full contact with the inside walls 18 of the mold sections 12, 13 to form the channel section 29 (partially illustrated in broken lines), the channel section hardens because of its contact with the cooled mold sections 12, 13, such that the adsorbent particles 22 are solidly attached to the inside wall 23 of the channel section. Thereafter, the mold sections 12, 13 are moved apart in the direction of the arrows, and the molded air conducting element can be removed.

In the illustrated example, the end plate 30 and the upper connection piece 31 must then be adapted to the given requirements, or the end plate 30 must be removed. It is also possible, however, to seal the lower region of the preform with a sealing fitting, which enters the preform, such that no airtight end is produced and less waste is generated as a result. The FIGURE illustrates only the schematic functioning of such an extrusion blow molding unit with injected adsorbent particles. The contour shaped by the mold sections 12, 13 can be far more complex, however, than in the example shown here.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A channel for conducting a gaseous medium comprising at least one channel section produced in an extrusion blow molding process, wherein the blow-molded channel section has adsorbent particles along its inside wall, which are attached to the inside wall of the channel in an interlocked manner.

2. A channel according to claim 1, wherein the blow-molded channel section is made of a thermoplastic synthetic resin material.

3. A channel according to claim 2, wherein the thermoplastic synthetic resin material is polypropylene.

4. A channel according to claim 1, wherein the inside wall of the blow-molded channel section has adsorbent particles only along a specified portion of its axial length.

5. A channel according to claim 1, wherein the adsorbent particles are comprised of activated carbon, zeolite or silica gel.

6. A method of producing a gas conducting channel section having adsorbent particles along its inside wall, which are attached to the inside wall of the channel in an interlocked manner, said method comprising:
extruding a tubular preform;
introducing the extruded preform while its walls are still soft into a blow mold having inside walls in the shape of the channel section;
sealing the ends of the preform in the blow mold; and
injecting a gas under pressure into the preform to inflate the preform and press the preform against the inside walls of the blow mold, and allowing the preform to solidify against the walls of the blow mold;
wherein adsorbent particles are introduced into the preform with the injected gas such that the particles are embedded in an interlocked manner in the inside wall of the preform.

7. A method according to claim 6, wherein the introduction of the adsorbent particles is controlled.

8. A method according to claim 7, wherein the amount of the introduced adsorbent particles is controlled.

9. A method according to claim 7, wherein the adsorbent particles are introduced at specified time intervals.

10. A method of separating hydrocarbons from an air stream, said method comprising passing the air stream through an air conducting channel according to claim 1.

11. A method according to claim 10, wherein the air stream is an intake air stream for an internal combustion engine.

12. A method according to claim 10, wherein the air stream is a ventilation air stream for a passenger compartment of a motor vehicle.
